(19) United States
(12) Patent Application Publication
(10) Pub. No.: US 2024/0076570 A1
(43) Pub. Date: Mar. 7, 2024

(54) AQUEOUS COATING COMPOSITION AND USE THEREOF

(71) Applicant: Ewald Dörken AG, Herdecke (DE)

(72) Inventors: Reiner Wark, Wuppertal (DE); Nicole Matthée, Herdecke (DE); Angela Kleinkorres, Wetter (DE); Hanna Smoll, Schwerte (DE); Anastasia von Rhein, Nachrodt-Wiblingwerde (DE); Martin Kunka, Bergkamen (DE); Marcel Roth, Düsseldorf (DE); Gerhard Reusmann, Essen (DE)

(73) Assignee: Ewald Dörken AG, Herdecke (DE)

(21) Appl. No.: 18/458,547

(22) Filed: Aug. 30, 2023

(30) Foreign Application Priority Data
Sep. 2, 2022 (EP) 22193742.8

(51) Int. Cl. C10M 107/28; C10M 103/02; C10M 103/06; C10M 107/04; C10M 111/04; C10M 125/26; C10M 169/04

(52) U.S. Cl. CPC C10M 107/28; C10M 103/02; C10M 103/06; C10M 107/04; C10M 111/04; C10M 125/26; C10M 169/04; C10M 2201/0413; C10M 2201/0663; C10M 2201/105; C10M 2205/0225; C10M 2209/0845; C10N 2050/02

(57) ABSTRACT

A coating composition for producing a coating with an adjustable coefficient of friction.

### CROSS REFERENCE TO RELATED APPLICATION

This application claims the benefit of European Patent Application Number EP 22193742.8, filed Sep. 2, 2022, which is incorporated herein by reference in its entirety.

### FIELD

The present invention relates to the technical field of coatings, in particular coatings for mass bulk materials.

### DETAILED DISCLOSURE

In particular, the present invention relates to an aqueous coating composition for producing a coating with an adjustable coefficient of friction. Further, the present invention relates to a method for producing a coating with an adjustable coefficient of friction and to the use of an aqueous coating composition for producing a coating with an adjustable coefficient of friction. Finally, the present invention relates to a coated substrate.

Fastening elements, in particular small parts such as bolts, nuts and screws, which are used for the mechanical fastening of components, in particular metal components, must comprise reproducible specific coefficients of friction so that they can be processed industrially.

The coefficient of friction μ indicates the ratio of frictional force to normal force; the higher the coefficient of friction, the higher the frictional force. The higher the frictional force, the less energy is transferred to the elastic or plastic elongation of the screw in the tightening process, resulting in a reduced so-called preload force. The preload force is usually specified to ensure reliable performance of the bolted joint, which is why the coefficient of friction must move within a defined window. This is of particular importance in the case of fastening materials such as bolts, screws, nuts or even rivets, since these are used for the purely mechanical fastening of components. On the one hand, the friction must be sufficiently high to prevent unintentional loosening of the compound, but at the same time it must be low enough to allow a complete and substance-to-substance bond.

In addition, the coefficients of friction must be set as constantly as possible to allow industrial processing, in particular using robots, for example for screws with a defined torque or for bolt rivets with always the same force. For this reason, small fastening parts are often coated in practice with special coating compositions in the form of topcoats, which are intended to set and influence the sliding and frictional properties of the parts in a desired manner.

The desired sliding and friction properties of screws or bolts are usually determined in accordance with DIN EN ISO 16047:2013-01, wherein a window of coefficient of friction μ of 0.09 to 0.16 is specified specifically for screws by the German Association of Automotive Manufacturers (VDA).

In order to set the desired coefficients of friction, particular topcoat compositions usually contain fluorinated plastic particles, in particular based on polyfluorotetraethylene (PTFE) or polyvinylidene fluoride (PVDF).

However, the use of perfluorinated or partially fluorinated compounds has several serious disadvantages: on the one hand, fluorinated polymers are relatively expensive, and on the other hand, they should be avoided from the point of view of environmental protection. During the producing of fluorinated compounds, in particular PTFE, not inconsiderable amounts of perfluorooctanoic acid (PFOA) are usually produced or used for the producing of these compounds. Perfluorooctanoic acid is virtually non-degradable in nature, accumulates in living organisms and comprises in particular liver-damaging, reproduction-toxic and carcinogenic properties. The producing of perfluorooctanoic acid and its precursor compounds has therefore been banned in the European Union since Jul. 4, 2020, with a few exceptions. PTFE can be purified with regard to PFOA, so that PTFE without PFOA can be used, but this is energy-intensive and makes the extraction of the raw material more expensive. PTFE itself is difficult to disperse in aqueous media, is not degradable in nature—it is a so-called persistent material—and should therefore be replaced by more environmentally compatible raw materials.

In addition, the producing or use of PTFE also produces polyfluorinated by-products and degradation products, which should not be released into the environment if possible.

For this reason, efforts are being made to replace polyfluorinated plastics with other materials wherever possible. However, this replacement is often not easy, since polyfluorinated or perfluorinated plastics comprise special and sometimes outstanding properties, in particular with regard to their hydrophobic wetting or non-wetting properties, their resistance to chemical and physical properties, and their excellent sliding properties.

One problem that arises in particular with screwed joints is heat release behavior, since the sliding properties of many plastics change at elevated temperatures. In particular, the sliding properties of many plastics improve when heated. However, this is undesirable for screwed joints, as there is otherwise a risk of unintentional joint loosening. Perfluorinated plastics, in particular PTFE and PVDF, do not exhibit this problematic behavior, or only to a limited extent, so that they are still the material of choice today for setting the sliding or frictional properties of fasteners in a targeted manner. PTFE is characterized in particular by its high melting point, which allows friction behavior to be optimized in higher temperature ranges.

Another problem, which occurs in particular when screws are tightened at high speeds, is the so-called stick-slip effect, also known as jerk-slip. In this case, the screw no longer moves smoothly during tightening, but instead starts to stick and slide. This results in a torque uncertainty on the one hand and a preload uncertainty on the other, which in turn can lead to a hidden risk of failure during operation. Stick-slip effects should therefore be avoided wherever possible, which is why the sliding and adhesive properties of bolts must be set particularly accurately and uniformly. So far, stick-slip effects can only be largely prevented by using topcoats containing fluoropolymers.

One disadvantage of fluorinated polymers, however, is that they should be used preferentially in solvent-based systems because of their hydrophobicity. For reasons of environmental protection and occupational safety, however, aqueous systems are increasingly preferred.

Up to now, the state of the art has lacked an aqueous coating system that allows the targeted setting of the coefficients of friction of small fastening parts in particular and that manages without the use of PTFE, and preferably entirely without the use of fluorinated polymers, and does so while meeting the requirements for the narrowly defined coefficient of friction window, heat release and stick-slip behavior.

An object of the present invention is thus to provide a coating composition which permits precise setting of the coefficients of friction of components, in particular fastening components, such as in particular screws, nuts, bolts or rivets, and which moreover does not require the use of PTFE and preferably dispenses entirely with fluorinated polymers.

Furthermore, it is an object of the present invention to provide a coating system which is at least largely free of organic solvents and is preferably free of organic solvents.

A further object of the present invention is to provide a coating system which largely prevents stick-slip effects.

Thus, subject-matter of the present invention according to a first aspect of the invention is an aqueous coating composition according to claim 1; further advantageous embodiments of this aspect of the invention are the subject-matter of the related dependent claims.

Again, another subject-matter of the present invention according to a second aspect of the present invention is the use of a coating composition according to claim 15.

Again, further subject-matter of the present invention according to a third aspect of the present invention is a method for producing a coating according to claim 16; further, advantageous embodiments of this aspect of the invention are the subject-matter of the related dependent claims.

Finally, a further subject-matter of the present invention according to a fourth aspect of the present invention is a metallic substrate according to claim 18; further advantageous embodiments of this aspect of the invention are the subject-matter of the related sub-claims.

It goes without saying that special features, characteristics, embodiments and advantages or the like, which are described below—for the purpose of avoiding unnecessary repetition—only with respect to one aspect of the invention, naturally apply accordingly with respect to the other aspects of the invention, without the need for express mention.

In addition, it applies that all value or parameter data or the like mentioned in the following can in principle be determined or determined with standardized or explicitly stated determination methods or with determination methods which are familiar to the person skilled in the art in this field.

Furthermore, it goes without saying that all weight- or quantity-related percentages are selected by the person skilled in the art in such a way that the total results in 100%.

With this proviso stated, the present invention will be described in more detail below.

Thus, the subject-matter of the present invention—according to a first aspect of the present invention—is an aqueous coating composition for producing a coating, in particular a topcoat, with an adjustable coefficient of friction, wherein the composition comprises
(a) an organic binding agent, wherein the binding agent comprises a copolymer of at least one unsaturated hydrocarbon and at least one unsaturated carboxylic acid, and
(b) a lubricant.

For, as the applicant has surprisingly found, topcoats with excellent sliding and friction properties can be obtained if a coating composition is used which comprises an organic binding agent comprising a copolymer of at least one unsaturated hydrocarbon, in particular an olefin, and at least one unsaturated carboxylic acid, and a lubricant. Such coating compositions can be readily formulated in aqueous media and, moreover, may be free of PTFE. Preferably, they are even entirely free of fluorinated polymers.

The present invention thus provides easy access to topcoats whose coefficients of friction can be set to values required for industrial production, in systems which are both solvent-free and free of fluorinated polymers, in particular free of PTFE. The coating composition according to the invention is thus superior both from the environmental point of view and from the point of view of occupational safety to the usually fluoropolymer-containing and solvent-based systems known to date.

Preferably, the organic binding agent already comprises certain slip properties. These slip properties of the binding agent are achieved in particular by segments of the copolymer which are built up from the polymerized unsaturated hydrocarbons, in particular polymerized olefins. The polar groups of the carboxylic acids cause the polymer to remain water-soluble or at least water-dispersible despite hydrophobic regions.

It has been shown that the sliding properties are again significantly improved and the coefficient of friction can be set stably, in particular also at elevated temperatures, if a lubricant is added to the organic binding agent.

In the context of the present invention, a lubricant is understood to be a chemical substance or a mixture of substances which changes the tribological properties of a coating, in particular reduces friction. In the context of the present invention, lubricants can be present in liquid or solid form, wherein the use of solid lubricants is preferred.

As previously stated, it is essential in the context of industrial production, in particular screw fastening by robots, that the sliding properties or coefficients of friction of coated fasteners, in particular screws, always assume comparable values in a reproducible manner. For this reason, VDA Guideline 235-101 defines a so-called friction coefficient window in which the coefficient of friction μ for fastening means, in particular bolts, nuts and screws, may lie. This friction coefficient window covers an interval of the friction coefficient μ of 0.09 to 0.16. The friction coefficient is determined in accordance with DIN EN ISO 16047:2013-01. If other friction coefficient windows are defined and desired, these can also be fulfilled by the inventive approaches described.

In the context of the present invention, it is preferred if the surface or coated substrate coated with the coating composition according to the invention comprises a coefficient of friction μ determined according to DIN EN ISO 16047:2013-01 in the range from 0.09 to 0.16.

In the case of screws, the coefficient of friction is determined both on the thread and on a flat surface, in particular the head of the screw. This dual determination is necessary because workpieces, in particular threaded parts, comprise a different coefficient of friction at the thread than at flat coated surfaces, such as the head of a screw. For example, screws that are designed as internal supports have a higher coefficient of friction at the thread and thus poorer sliding properties than at the head of the screw, which rests on a nut or threaded washer. If the screw is an outer carrier, the coefficient of friction is higher at the head than at the thread.

Since the friction coefficient measurement for both areas (thread and flat surface) are included in the friction coefficient determination for the entire workpiece, workpieces coated with a coating without lubricant often comprise an undesirably high friction coefficient. According to the invention, however, the use of lubricants can be dispensed with.

Within the scope of the present invention, it is preferably provided that for threaded parts, such as screws, the coefficient of friction for both the thread and the flat surface each lie within the aforementioned coefficient of friction window of the coefficient of friction μ of 0.09 to 0.16.

Since the test regulation mentioned in DIN EN ISO 16047:2013-01 applies to a single tightening, a test arrangement for a multiple tightening is additionally specified in the test sheet according to VDA 235-203.

Within the scope of the present invention, it is preferably further provided that the above-mentioned friction coefficient window for the coefficient of friction μ of 0.09 to 0.16 is also fulfilled in the case of a multiple tightening, both on the thread and on flat surfaces.

In addition, the hot loosening behavior of workpieces, in particular fasteners such as screws or bolts, is also critical, especially if these are installed in the vicinity of aggregates such as engines. For this reason, VDA test sheet 235-203 defines a test arrangement at temperature load at 150° C., wherein a coefficient of friction window μ of 0.06 must not be undershot.

Within the scope of the present invention, it is therefore preferred if the workpieces coated with the coating composition according to the invention comprise a coefficient of friction μ in the range from 0.09 to 0.16 at 150° C. according to VDA test sheet 235-203. This friction coefficient window is preferably fulfilled both for the total friction coefficient and, in the case of threaded workpieces, at the thread and at the flat surface.

In the context of the present invention, an unsaturated hydrocarbon is to be understood as a preferably non-polar organic compound which has at least one unsaturated bond, in particular at least one carbon-carbon double bond or carbon-carbon triple bond. The unsaturated hydrocarbons are primarily alkenes and alkynes, in particular compounds having vinyl and/or alkenyl groups, although aromatics and heteroaromatics having alkene or alkyne side chains, in particular having vinyl and/or alkenyl groups, are also included. Furthermore, the hydrocarbons may also be substituted, for example with halides, and alcohol, amine or thiol functions. Preferentially, however, the hydrocarbons are unsubstituted hydrocarbons, i.e., alkenes and alkynes or mixtures thereof.

In the context of the present invention, an unsaturated carboxylic acid means a carboxylic acid which comprises a carbon double bond or a carbon triple bond. In addition to the acid group, the carboxylic acids may optionally be provided with further functional groups, in particular alcohol, thiol, amine and ether functions or the like. Carboxylic acids also include in particular derivatives of carboxylic acids, in particular esters and amides thereof.

In the context of the present invention, it is further preferred if the copolymer of at least one unsaturated hydrocarbon and at least one unsaturated carboxylic acid is a block copolymer. In this context, it is more preferably if the block copolymer comprises blocks of segments of the unsaturated hydrocarbon. The unsaturated hydrocarbons in particular contribute to the fact that the binding agent of the coating composition, in particular the topcoat composition, already comprises excellent slip properties and allows the friction coefficient to be set in a targeted manner.

Typically, it is provided in the context of the present invention that the unsaturated hydrocarbon is selected from the group of aliphatic hydrocarbons with vinyl groups, aromatic hydrocarbons with vinyl groups, aliphatic hydrocarbons with alkynyl groups, aromatic hydrocarbons with alkynyl groups and mixtures thereof. Particularly obtainable results are obtained if the unsaturated hydrocarbon is selected from the group of aliphatic hydrocarbons with vinyl groups, aromatic hydrocarbons with vinyl groups and mixtures thereof. It is more preferably the case if the unsaturated hydrocarbon is an aliphatic hydrocarbon with vinyl groups. The unsaturated hydrocarbons are preferably alkenes and/or alkynes, preferably alkenes, as stated above.

The use of hydrocarbons with vinyl groups or alkenes in particular makes it possible to generate nonpolar segments in the copolymers which can impart slip properties to the binding agent or coating and thus promote a specific friction coefficient adjustment.

Particularly good results are obtained within the scope of the present invention if the unsaturated hydrocarbon is selected from aliphatic and/or aromatic C₂- to C₂₀-compounds with alkynyl groups, aliphatic and/or aromatic C₂- to C₂₀-compounds with vinyl groups and mixtures thereof, in particular aliphatic and/or aromatic C₂- to C₁₂-compounds with alkynyl groups, aliphatic and/or aromatic C₂- to C₁₂-compounds with vinyl groups and mixtures thereof, preferably aliphatic and/or aromatic C₂- to C₁₀-compounds with alkynyl groups, aliphatic and/or aromatic C₂- to C₁₀-compounds with vinyl groups and mixtures thereof, preferentially aliphatic and/or aromatic C₂- to C₈-compounds with alkynyl groups, aliphatic and/or aromatic C₂- to C₈-compounds with vinyl groups and mixtures thereof, in particular preferentially aliphatic C₂- to C₆-compounds with vinyl groups, more preferentially aliphatic C₂- to C₄-alkenes with vinyl groups, particularly preferred C₂- and C₃-alkenes. It is well proven if the unsaturated hydrocarbon is selected from the group of aliphatic C₂- to C₄ -alkenes with vinyl groups. In this context, it is again preferred if the unsaturated hydrocarbon is selected from C₂- and C₃-alkenes and mixtures thereof. It is even more preferred in the context of the present invention if a C₂-alkene, i.e. ethene, is used.

In the context of the present invention, it is equally preferred if the unsaturated hydrocarbon is selected from the group of styrene, 1-hexene, 1-pentyne, 1-butyne, 2-butyne, propyne, ethyne, 1-hexene, 1-pentene, 1-butene, 2-butene, propene, ethene and mixtures thereof. Preferentially, the unsaturated hydrocarbon is selected from the group of 1-hexene, 1-pentene, 1-butene, 2-butene, propene, ethene, 1-hexene, 1-pentene, 1-butene, 2-butene, propene, ethene and mixtures thereof. Particularly good results are obtained if the unsaturated hydrocarbon is selected from styrene, 1-butene, 1-propene, ethene and mixtures thereof, in particular 1-butene, 1-propene, ethene and mixtures thereof, preferably propene, ethene and mixtures thereof. It is even more preferred in the context of the present invention if the unsaturated hydrocarbon is ethene.

As far as the unsaturated carboxylic acid is concerned, it can be selected from a wide range of compounds. However, it has proved advantageous if the unsaturated carboxylic acid is selected from alkenoic acids. Particularly good results are obtainable in this case if the unsaturated carboxylic acid is selected from C₂- to C₂₀-alkenoic acids, in particular C₂- to C₁₂-alkenoic acids, preferably C₂- to C₁₀-alkenoic acids, preferentially C₂- to C₄-alkenoic acids, in particular preferentially C₂- and C₃-alkenoic acids, and their esters and amides.

Preferably, however, it is intended that the unsaturated carboxylic acids be used as free acids.

In the context of the present invention, it has been well proven if the unsaturated carboxylic acid is selected from the group consisting of acrylic acid, esters of acrylic acid with C₁- to C₁₀-alcohols, methacrylic acid, esters of methacrylic acid with C₁- to C₁₀-alcohols, fumaric acid, maleic acid and mixtures thereof. Particularly good results are obtained in this context if the unsaturated carboxylic acid is selected from the group consisting of acrylic acid, ethers of acrylic acid with C₁- to C₁₀-alcohols, methacrylic acid and esters of methacrylic acid with C₁- to C₁₀-alcohols and mixtures thereof.

Even further preferred in the context of the present invention is if the unsaturated carboxylic acid is selected from the group consisting of acrylic acid, acrylic acid methyl ester, acrylic acid ethyl ester, acrylic acid butyl ester, acrylic acid isobutyl ester, acrylic acid 2-ethylhexyl ester, methacrylic acid, methacrylic acid methyl ester, methacrylic acid ethyl ester, methacrylic acid butyl ester, methacrylic acid isobutyl ester and methacrylic acid hexyl ester. In this context, it has been particularly well proven if the unsaturated carboxylic acid is selected from the group of acrylic acid, acrylic acid methyl ester, acrylic acid ethyl ester, methacrylic acid, methacrylic acid methyl ester and methacrylic acid ethyl ester, preferably acrylic acid and methacrylic acid.

As far as the molecular weight of the copolymer is concerned, this can naturally vary over a wide range. However, it has been well proven if the copolymer comprises a weight-average molecular weight Mw in the range of 2,000 to 250,000 g/mol, in particular 5,000 to 200,000 g/mol, preferably 10,000 to 150,000 g/mol, preferentially 15,000 to 100,000 g/mol.

The molecular weights for polymeric compounds given in the context of the present invention refer to the weight-average molecular weight Mw, in which the mass of the individual polymeric compounds is weighted by their weight fraction. The molecular weights or molecular weight distribution can be determined by various standardized procedures and methods, such as light scattering, rheology, mass spectrometry, permeation chromatography, etc. However, the methods used to determine the molecular weight distribution are familiar to those skilled in the art and do not require further explanation. For example, the molecular weights of the polymers used can be determined in particular by means of a GPC method, in particular on the basis of DIN 55672 with polymethyl¬methacrylate or polystyrene as the standard.

The coating composition can contain the organic binding agent in almost any quantity. However, it has been well proven if the coating composition contains the organic binding agent in amounts of 2 to 70 wt. %, in particular 5 to 60 wt. %, preferably 10 to 50 wt. %, preferentially 10 to 40 wt. %, based on the coating composition.

As previously stated, the coating composition contains a lubricant. Preferentially, the lubricant is selected from the group consisting of organic lubricants, inorganic lubricants and mixtures thereof. However, particularly good results are obtainable in the context of the present invention if the lubricant is an organic lubricant.

The lubricants used in the context of the present invention are usually in particulate form. In this regard, the lubricants typically comprise absolute particle sizes in the micrometer range.

In the context of the present invention, particularly good results are obtained if the lubricant is selected from the group consisting of waxes, graphene, graphite, boron nitride, molybdenum disulfide, plastic particles, in particular polyetherketone (PEK), polyetheretherketone (PEEK), polyphenylene sulfide (PPS), polyethersulfone (PES), polyetherimide (PEI), polyamideimide (PAI) and mixtures thereof, micronized sulfur and mixtures thereof. Preferentially, the lubricant is selected from the group of waxes, graphene, graphite, boron nitride, molybdenum disulfide and mixtures thereof. Particularly good results are obtained in the context of the present invention if the lubricant is a wax.

In the context of the present invention, a wax is to be understood in particular as a natural or artificially obtained substance which is usually kneadable at 20° C., solid to brittle hard, coarse to fine crystalline, translucent to opaque, but not glassy, and which melts at above 40° C. without decomposition. Even slightly above the melting point, a wax is usually relatively low viscosity and non-threading. Waxes differ from similar synthetic or natural products mainly in that they usually change to the molten, low-viscosity state between about 50 and 90° C., and in exceptions up to about 200° C., and are practically free of ash-forming compounds. Waxes form pastes or gels and usually burn with a sooty flame. According to their origin, waxes are divided into three groups, namely natural waxes, semi-synthetic waxes and synthetic waxes. Natural waxes consist in particular of vegetable waxes, such as candelilla wax, carnauba wax or montan wax, animal waxes, such as beeswax, lanolin and brushing fat, mineral waxes, such as ceresin and ozokerite, and petrochemical waxes, in particular petrolatum, kerosene waxes and microwaxes. Semi-synthetic waxes are in particular hard waxes, such as montan ester waxes and hydrogenated jojoba waxes. Synthetic waxes are, for example, polyalkylene waxes or polyethylene glycol waxes.

If the lubricant is a wax, it has been well proven if the wax is selected from the group consisting of natural waxes, semi-synthetic waxes, synthetic waxes and mixtures thereof. Preferentially, the wax is a synthetic wax.

Similarly, it is preferred in the context of the present invention if the wax is selected from the group of beeswax, carnauba wax, montan wax, modified montan wax, amide wax, polypropylene wax, polyethylene wax, HD PE wax (high-density polyethylene wax), oxidized HDPE wax, ethylene vinyl acetate wax, polyethylene glycol wax, polyester wax, Fischer-Tropsch wax and mixtures thereof, preferentially polypropylene wax, polyethylene wax, HDPE wax, oxidized HDPE wax, ethylene vinyl acetate wax, polyethylene glycol wax, polyester wax, Fischer-Tropsch wax and mixtures thereof.

Particularly good results are obtainable in this context if the wax is selected from the group consisting of polypropylene wax, polyethylene wax, HDPE wax, oxidized HDPE wax, Fischer-Tropsch wax and mixtures thereof.

Even more preferably in the context of the present invention is if the wax is a polyethylene wax (PE wax).

Waxes, in particular synthetic waxes, preferably polyethylene wax, can be used as lubricants to set the sliding and friction properties of the coating composition excellently. In particular, combinations of organic binding agent and a wax-based lubricant exhibit excellent and consistent coefficients of friction, in particular also under multiple tightening and also under thermal stress.

Now, as far as the amount in which the coating composition contains the lubricant is concerned, this can vary over a wide range. However, it has been found to be preferable if the coating composition contains the lubricant in amounts of 0.1 to 10 wt. %, in particular 0.3 to 8 wt. %, preferably 0.5 to 5 wt. %, preferably 0.8 to 4 wt. %, based on the coating composition.

In the context of the present invention, it is advantageously provided that the coating composition is free of fluorine-containing compounds, in particular free of organic fluorine-containing compounds. It is even more preferably provided in the context of the present invention that the coating composition is free from fluorinated polymer particles, in particular is free from PTFE and PVDF.

It is a great advantage of the present invention that coating compositions with selectively adjustable coefficients of friction can be provided which do not involve the use of fluorinated polymer particles of concern. In particular, within the scope of the present invention, it is possible to provide coating compositions having excellent slip and friction properties that are completely free of the use of fluorinated organic compounds.

Within the scope of the present invention, it may further be provided that the coating composition comprises at least one thickener and/or rheology additive.

Thickeners and/or rheological additives serve in particular to set the viscosity as well as the flow or even the layer thickness with which the composition according to the invention can be applied to a substrate.

If the coating composition contains a thickener and/or a rheological additive, the coating composition usually contains the thickener and/or the rheological additive in amounts of 0.01 to 5 wt. %, in particular 0.05 to 3 wt. %, preferably 0.1 to 2 wt. %, based on the coating composition.

The thickener and/or the rheological additive can be selected from a variety of suitable compounds and compound classes. However, it has been well proven if the thickener and/or the rheological additive is selected from the group of ethyl cellulose, silicic acid and mixtures thereof. More preferably, the thickener and/or the rheological additive is silicic acid, in particular fumed silica.

According to another preferred embodiment of the present invention, the coating composition comprises
(a) an organic binding agent, wherein the binding agent comprises a copolymer of at least one unsaturated hydrocarbon and at least one unsaturated carboxylic acid,
(b) a lubricant; and
(c) a thickener and/or a rheology additive.

For this preferred embodiment of the present invention, all of the advantages, features and special characteristics previously mentioned in context with the further embodiments and features of the coating composition according to the invention apply accordingly.

Furthermore, it may be provided in the context of the present invention that the coating composition comprises platelet-shaped particles.

In the context of the present invention, platelet-shaped particles, which are also often referred to as flaky particles, are to be understood as particles whose thickness is significantly less than their length and width, i.e. whose extension in one spatial direction is significantly less than in the other two spatial directions. Usually, the aspect ratio, i.e. the ratio of the length or width of the particles to the thickness of the particles is in the range of 2:1 to 100:1, in particular 4:1 to 50:1, preferably 5:1 to 20:1, preferentially 8:1 to 15:1.

The platelet-shaped particles are preferably selected from the group consisting of metal flakes, glass flakes, layered silicates and mixtures thereof. The layered silicates are preferably selected from the group of mica, talc, bentonite, kaolin and mixtures thereof. In this context, the metal flakes are preferably selected from the group of aluminum flakes, zinc flakes, copper flakes and mixtures thereof.

Preferably, the platelet-shaped particles are metal flakes, in particular selected from the group of aluminum flakes, zinc flakes, copper flakes and mixtures thereof. It is more preferably if the platelet-shaped particles are aluminum flakes.

If the coating composition comprises platelet-shaped particles, the coating composition typically comprises platelet-shaped particles in amounts of 0.3 to 8 wt. %, preferably 0.5 to 5 wt. %, preferentially 0.8 to 4 wt. %, based on the coating composition.

Particularly good results are obtainable in this context if the coating composition contains a total amount of lubricant and platelet-shaped particles in the range of 0.5 to 20 wt. %, in particular 1 to 18 wt. %, preferably 1.5 to 15 wt. %, preferably 2 to 12 wt. %, based on the coating composition.

The additional use of platelet-shaped particles in the coating composition allows the coefficients of friction and the sliding properties of the coated substrates to be set precisely and, in particular, the stick-slip effect to be avoided even better. In addition, the use of platelet-shaped particles also allows the coating composition to be dried or cured at high temperatures without an increase in the coefficient of friction being observed. This is surprising because topcoats containing lubricants, in particular in the case where they contain waxes, comprise a higher coefficient of friction after exposure to temperature, especially after drying at high temperatures. This is in particular due to the fact that the lubricants, in particular waxes, pass into the gas phase or are thermally decomposed during the drying process. Surprisingly, topcoats containing platelet-shaped particles in addition to a lubricant do not show this increase in the coefficient of friction. Without wishing to commit to a theory, this is probably due to the fact that the platelet-shaped particles act as a diffusion barrier and, on the one hand, retard the penetration of oxygen into the coating and thus slow down decomposition of the lubricant and, on the other hand, when evaporable or sublimed lubricants are used, prevent the lubricant from passing into the gas phase.

Particularly good results are obtainable if the weight ratio of platelet-shaped particles to lubricant is in the ratio of 1:0.8 to 1:1.8, in particular 1:1 to 1:1.6, preferably 1,:1.1 to 1:1.4, based on the weight of platelet-shaped particles and the weight of lubricant in the coating composition.

According to a preferred embodiment of the present invention, the coating composition comprises
(a) an organic binding agent, wherein the binding agent comprises a copolymer of at least one unsaturated hydrocarbon and at least one unsaturated carboxylic acid,
(b) a lubricant,
(c) a thickener and/or a rheology additive, and
(d) platelet-shaped particles.

For this preferred embodiment of the present invention, all the advantages, features and special characteristics previously mentioned in context with the further embodiments and features of the coating composition according to the invention apply accordingly.

In addition, it may be provided that the coating composition comprises at least one further additive.

If the coating composition comprises a further additive, the coating composition comprises the further additive in amounts of 0.01 to 5 wt. %, in particular 0.05 to 3 wt. %, preferably 0.1 to 2 wt. %, based on the coating composition.

Particularly good results are obtained in this context if the further additive is selected from the group of wetting agents, preservatives, stabilizers, acids and/or bases, defoaming components, film formers, leveling agents, UV absorbers, fillers, pH stabilizers and pH adjusting agents.

According to a preferred embodiment of the present invention, it is thus provided that the coating composition comprises
(a) an organic binding agent, wherein the binding agent comprises a copolymer of at least one unsaturated hydrocarbon and at least one unsaturated carboxylic acid,
(b) a lubricant,
(c) a thickener and/or a rheology additive, and
(d) platelet-shaped particles
(e) a further additive.

For this particular embodiment of the present invention, all advantages, features and special characteristics previously mentioned in context with the further embodiments and features of the present invention apply accordingly.

According to a preferred embodiment of the present invention, it is provided that the coating composition further comprises an inorganic binding agent. The addition of an inorganic binding agent in particular improves the wear resistance and mechanical resistance of the coating. In addition, the use of inorganic coatings is also commercially desirable because they are often inexpensive to produce or obtain on a large industrial scale. If the coating composition includes an inorganic binding agent, the inorganic binding agent is typically a silicon-containing binding agent.

Preferably, the inorganic binding agent is selected from silanes, silane hydrolysates, silicates, polysiliconates and mixtures thereof.

Particularly good results are obtained in this context if the inorganic binding agent is selected from the group of silanes, in particular trialkoxysilanes and tetraalkoxysilanes, preferably vinylsilanes, aminesilanes, phenoxysilanes and/or epoxysilanes, tetraethyl orthosilicate (TEOS), tetramethyl orthosilicate (TMOS), silane hydrolysates, colloidal silicic acid, water glasses or silicates, in particular lithium water glass, sodium water glass, potassium water glass and mixtures thereof. In particular, the silanes that can preferably be used are those mentioned below in the producing of silane-modified silicates.

According to a preferred embodiment of the present invention, the inorganic binding agent is in particular free of lithium compounds. Within the scope of the present invention, particularly good coating and slip properties can also be obtained if the lithium polysilicate (lithium water glass), which is usually preferred, is not used. This is a particular advantage of the present invention, since lithium demand and subsequently lithium prices are expected to increase due to the increasing use of lithium ion batteries and lithium ion accumulators, in particular in the automotive sector.

Preferably, the inorganic binding agent is selected from the group of silanes, in particular trialkoxysilanes and tetraalkoxysilanes, preferably vinylsilanes, aminesilanes, phenoxysilanes and/or epoxysilanes, tetraethyl orthosilicate (TEOS), tetramethyl orthosilicate (TMOS), silane hydrolysates, colloidal silicic acid (silic sol), sodium water glass, potassium water glass and mixtures thereof. More preferably, the inorganic binding agent is selected from the group of sodium water glass, potassium water glass and mixtures thereof.

According to a preferred embodiment of the present invention, the inorganic binding agent comprises or consists of a mixture of water glass and/or colloidal silicic acid with silane hydrolysate and/or silane. Preferably, the inorganic binding agent comprises a mixture of water glass and/or colloidal silicic acid with silane hydrolysate and/or silane. These mixtures also do not show carbonation at alkaline pH values.

In accordance with this embodiment, it is preferred if the organic binding agent contains the water glass and/or the colloidal silicic acid in a ratio by weight to the silane hydrolysate and/or silane in the range from 15:1 to 1:2, in particular 1:1 to 1:1.5, preferably 5:1 to 1:1, preferentially 4:1 to 1:1.

Similarly, according to this embodiment, it has been well proven if the inorganic binding agent, in particular before mixing with the organic binding agent, is set to a pH of less than 11, in particular less than 9, preferably less than 8.5. Preferably, the inorganic binding agent, in particular before mixing with the organic binding agent, is set to a pH value of less than 8, in particular in the range from pH 5 to pH 7.5.

In mixtures of water glasses and/or colloidal silicic acids with silane hydrolysates and/or silanes, in particular, a significantly weaker or eliminating carbonation, i.e. the absorption of carbon dioxide from the air with subsequent production of carbonates, is observed, in particular at pH values in the alkaline range. Carbonation leads, in particular in the case of topcoats, to an undesirable impairment of the surface properties, especially the appearance, due to turbidity of the topcoat The coatings then often appear dusty, which is not desirable. Another advantage of the mixtures described is that the pH of the inorganic binding agent and/or the coating composition can be set in the acidic range without precipitating the silicate or silicic acid.

Particularly good results are obtained in this context if the inorganic binding agent is a silane-modified silicate compound or a silane-modified water glass. The silane-modified silicate compound or silane-modified water glass is usually obtainable by at least partially hydrolyzing and/or condensing at least one silane in the presence of at least one silicate at a pH equal to or greater than 8.

Similarly, when silane-modified silicate compounds or silane-modified water glasses are used, no carbonation is observed and the pH of the inorganic binding agent or coating composition can be set to values less than or equal to 7 without precipitation of the silicate. In this case, the pH can be adjusted by adding acids. Use of the silane-modified silicate compounds or the silane-modified water glasses in the neutral or acidic pH range is preferred, in particular because the absorption of carbon dioxide in the form of carbonates is significantly reduced in the acidic range.

Preferably, the method for producing a silane-modified silicate or a silane-modified water glass is carried out in such a way that a silane is at least partially hydrolyzed in the presence of a silicate compound or a water glass at a pH equal to or greater than 8, in particular greater than 11, to give a silane-modified silicate or water glass, and then the pH is set to values lower than 8.5, in particular lower than 8, preferably in the range from 4 to 7, in particular by adding acid.

It is also possible to set a pH value between 2 and 4 during acidification, which can be achieved and maintained without causing precipitation or flocculation of the silane-modified silicate compound or silane-modified water glass.

A beneficial effect is already seen if only partial hydrolysis or condensation of silane occurs in the presence of silicates in aqueous solution in the alkali. Frequently, however, the hydrolysis or condensation of silane in the presence of silicates to form a silane-modified silicate compound or a silane-modified water glass is carried out completely in the alkaline. Partial hydrolysis of silane and silicate in aqueous alkaline solution can be continued after acidification to a pH of 7 or less, up to complete hydrolysis if desired.

Also according to this embodiment, in particular the previously mentioned compounds lithium water glass, sodium water glass, potassium water glass and mixtures thereof are used as water glass or silicate, preferably sodium water glass, potassium water glass and mixtures thereof.

For producing silane-modified silicate compounds or water glasses, an epoxy-functional, phenoxy-functional, vinyl-functional or amino-functional silane is advantageously used. More preferably, silanes comprising at least one Si—C bond, i.e. a bond between a silicon and a carbon atom, are used. Different silanes can be used with each other in admixture. Particularly suitable silanes are methacryloxymethyltrimethoxysilane, methacryloxymethyltriethoxysilane, 3-aminopropylmethyldimethoxy silane, 3-aminopropyltriethoxysilane, N-(2-aminoethyl)-3-aminopropylmethyldimethoxy silane, and 3-mercaptopropyltrimethoxysilane, N-(2-aminoethyl)-3-aminopropyltrimethoxysilane, N-(2-aminoethyl)-3-aminopropyl¬trimethoxysilane, N-cyclohexyl-3-aminopropyltrimethoxysilane, N-cyclohexylamino-methyltriethoxysilane, 3-aminopropyltriethoxysilane, 3-(2-aminomethylamino)propyltriethoxysilane, N-(2-aminoethyl)-3-aminopropylmethyldimethoxysilane, 3-aminopropyltrimethoxysilane, 3-ureidopropyltrimethoxysilane, vinyltrimethoxysilane, vinyldimethoxymethylsilane, vinyltriethoxysilane, vinyltriacetoxysilane, 3-methacryloxypropyltrimethoxysilane, methacryloxymethyl)methyldimethoxysilane, methacryloxymethyltrimethoxysilane, 3-methacryloxypropyltriacetoxysilane, N-methyl[3-(trimethoxysilyl)propyl]carbamate, N-trimethoxysilylmethyl-O-methylcarbamate, N-dimethoxy(methyl)silylmethyl-O-methylcarbamate, tris-[3-(trimethoxysilyl)propyl]-isocyanurate, 3-glycidoxypropyltrimethoxysilane, 3-glycidoxypropyltriethoxysilane, methyltrimethoxysilane, methyltriethoxysilane, dimethyldimethoxysilane, dimethyldiethoxysilane, trimethylethoxysilane, isooctyltrimethoxysilane, isooctyltriethoxysilane, hexadecyltrimethoxysilane, (cyclohexyl)methyldimethoxysilane, dicyclopentyldimethoxysilane, phenyltriethoxysilane, triacetoxyethylsilane, 1,2-bis(triethoxysilyl)ethane.

In producing the silane-modified silicates, silane and silicate are each advantageously used in a weight ratio of 2:1 to 1:10, in particular 1:1 to 1:5, preferably 1:1 to 1:3, preferentially 1:1 to 1:2. The silane can be used as a single compound or as a mixture of silanes, and the same applies to the silicate. For further details on producing silane-modified silicates or water glasses, reference can be made to WO 2016/107791 A1, the disclosure content of which is fully encompassed by the present invention.

If the coating composition comprises an inorganic binding agent, the coating composition typically comprises the inorganic binding agent in amounts of 1 to 30 wt. %, in particular 2 to 25 wt. %, preferably 3 to 20 wt. %, preferentially 5 to 15 wt. %, based on the coating composition.

If the coating composition contains an inorganic binding agent, it has been well proven if the coating composition contains the organic binding agent in amounts of 1 to 40 wt. %, in particular 2 to 30 wt. %, preferably 3 to 25 wt. %, preferentially 5 to 20 wt. %, based on the coating composition.

By combining an organic binding agent and an inorganic binding agent, the best results are obtainable in the context of the present invention.

In the context of the present invention, it has been well proven if the coating composition contains a total content of binding agent, i.e. the sum of organic and inorganic binding agent, in amounts of 2 to 70 wt. %, in particular 5 to 60 wt. %, preferably 10 to 50 wt. %, preferably 15 to 40 wt. %, based on the coating composition.

Thus, a preferred coating composition comprises
(a1) an organic binding agent, wherein the binding agent comprises a copolymer of at least one olefin and at least one unsaturated carboxylic acid,
(a2) an inorganic binding agent, and
(b) a lubricant.

For this preferred embodiment of the present invention, all special features, characteristics as well as advantages, which are mentioned before in context with the further embodiments and features, apply accordingly.

According to a further preferred embodiment of the present invention, the coating composition comprises
(a1) an organic binding agent, wherein the binding agent comprises a copolymer of at least one olefin and at least one unsaturated carboxylic acid,
(a2) an inorganic binding agent,
(b) a lubricant, and
(c) a thickener and/or a rheology additive.

For this preferred embodiment of the present invention, all special features, characteristics as well as advantages, which are mentioned before in context with the further embodiments and features, apply accordingly.

According to a preferred embodiment of the present invention, it is thus provided that the coating composition comprises
(a1) an organic binding agent, wherein the binding agent comprises a copolymer of at least one olefin and at least one unsaturated carboxylic acid,
(a2) an inorganic binding agent,
(b) a lubricant,
(c) a thickener and/or a rheology additive, and
(d) a further additive.

For this preferred embodiment of the present invention, all the advantages, features and special characteristics previously mentioned in context with the further embodiments and features of the coating composition according to the invention apply accordingly.

According to a preferred embodiment of the present invention, it is thus provided that the coating composition comprises
(a1) an organic binding agent, wherein the binding agent comprises a copolymer of at least one olefin and at least one unsaturated carboxylic acid,
(a2) an inorganic binding agent,
(b) a lubricant,
(c) a thickener and/or a rheology additive,
(d) a further additive, and
(e) platelet-shaped particles.

For this particular embodiment of the present invention, all advantages, features and special characteristics previously mentioned in context with the further embodiments and features of the present invention apply accordingly.

Furthermore, it may be provided that the coating composition comprises a filler.

If the coating composition comprises a filler, the coating composition typically comprises the filler in amounts of 0.5 to 50 wt. %, in particular 1 to 40 wt. %, preferably 5 to 35 wt. %, preferentially 10 to 30 wt. %, based on the coating composition.

Particularly good results are obtained if the filler is selected from calcium carbonate, barium sulfate, talc and mixtures thereof.

According to a preferred embodiment of the present invention, it is thus provided that the coating composition comprises
(a1) an organic binding agent, wherein the binding agent comprises a copolymer of at least one olefin and at least one unsaturated carboxylic acid,
(a2) an inorganic binding agent,
(b) a lubricant,
(c) a thickener and/or a rheology additive,
(d) a further additive, and
(e) a filler.

For this particular embodiment of the present invention, all of the advantages, features and special characteristics previously mentioned in context with the other embodiments and features of the present invention apply accordingly.

According to a preferred embodiment of the present invention, it is thus provided that the coating composition comprises
(a1) an organic binding agent, wherein the binding agent comprises a copolymer of at least one olefin and at least one unsaturated carboxylic acid,
(a2) an inorganic binding agent,
(b) a lubricant,
(c) a thickener and/or a rheology additive,
(d) a further additive,
(e) platelet-shaped particles, and
(f) a filler.

For this particular embodiment of the present invention, all advantages, features and special characteristics previously mentioned in context with the further embodiments and features of the present invention apply accordingly.

As previously stated, the composition according to the invention is an aqueous composition, that is, the composition according to the invention contains water as a solvent or dispersant. Typically, the composition according to the invention contains water in amounts of 40 to 98 wt. %, in particular 50 to 95 wt. %, preferably 60 to 90 wt. %, preferentially 60 to 85 wt. %, based on the coating composition.

In addition, the coating composition preferably comprises only small amounts of organic solvents and volatile organic compounds (VOCs). Typically, the coating composition contains organic solvents and volatile organic compounds in amounts of less than 3 wt. %, in particular less than 1 wt. %, preferably less than 0.5 wt. %, more preferably less than 0.3 wt. %, particularly preferably less than 0.1 wt. %, based on the coating composition. Preferably, the coating composition is free of organic solvents and volatile organic compounds.

Now, as far as the viscosity of the coating composition according to the invention is concerned, this can vary within wide ranges. However, particularly good results are obtainable in the context of the present invention if the coating composition comprises a Brookfield dynamic viscosity at 20° C. in the range from 2 to 5,000 mPas, in particular from 5 to 1,000 mPas, preferably from 5 to 500 mPas, preferentially from 10 to 100 mPas, in particular preferably from 30 to 50 mPas. With viscosities in the above-mentioned ranges, particularly thin and uniform topcoat coatings can be obtained.

A further subject-matter of the present invention—according to a second aspect of the present invention—is the use of an aforementioned coating composition as a topcoat for producing a coating with a selectively adjustable coefficient of friction on a metallic substrate, in particular a metallic substrate provided with a cathodic corrosion protection coating.

For further details on this aspect of the invention, reference can be made to the explanations on the other aspects of the invention, which apply in accordance with the use according to the invention.

Again, another subject-matter of the present invention—according to a third aspect of the present invention—is a method for producing a coating with an adjustable coefficient of friction, wherein
(a) in a first method step, a substrate which is provided at least in some areas with a cathodic corrosion protection coating is provided,
(b) in a second method step following the first method step (a), a coating composition according to one of the claims 1 to 14 is applied to the substrate at least in some areas, and
(c) in a third method step following the second method step (b), the coating composition applied in the second method step (b) is dried.

In the context of the present invention, it is in particular preferred if in the third method step (c) the coating composition applied to the substrate in the second method step (b) is cured and/or crosslinked.

Typically, the substrate comprises a metal or consists of a metal. Preferably, the substrate consists of a metal. Particularly good results are obtained in this context if the metal is selected from the group consisting of iron, aluminum, magnesium and mixtures and alloys thereof

In the context of the present invention, it is particularly preferred if the metal is selected from iron and its alloys, in particular a steel.

In the context of the present invention, a substrate means an article that can be coated with the coating composition.

Typically, in the context of the present invention, the substrate is selected from sheets, moldings, small parts and mixtures thereof.

It is particularly preferred in this context if the substrate is a small part, preferably mass bulk material, in particular selected from screws, nuts, bolts, washers, rivets and mixtures thereof

It is particularly preferred in the context of the present invention if the substrate is a screw or a nut, in particular a bolt.

Especially in the case of screws, the specific advantages of the coating composition and method according to the invention, namely the specific setting of the coefficient of friction, are particularly effective.

As far as the cathodic corrosion protection coating is concerned, which is applied to the substrate at least in some areas, preferably over the entire surface, it usually comprises a metal selected from the group consisting of zinc, aluminum, magnesium, nickel and mixtures and alloys thereof.

Preferably, the cathodic corrosion protection coating comprises zinc and alloys thereof.

It has been well proven in the context of the present invention if the cathodic corrosion protection coating is selected from the group of zinc-containing coatings, in particular electroplated zinc coatings, in particular electroplated zinc-nickel coatings, hot-dip galvanized coatings, zinc powder coatings, in particular zinc paints, and zinc flake coatings. Preferably, the cathodic corrosion protection coating is selected from the group of electroplated zinc coatings, in particular electroplated zinc-nickel coatings, zinc powder coatings and zinc flake coatings. Zinc powder coatings and zinc flake coatings may in particular also comprise zinc alloys. Preferably, the zinc alloys comprise aluminum and/or magnesium in addition to zinc, preferably aluminum and magnesium.

In the context of the present invention, it has been well proven if in method step (b) the coating composition is applied to the substrate or the cathodic corrosion protection coating with a layer thickness in the range from 1 to 12 μm, in particular from 1 to 10 μm, preferably from 1 to 8 μm, in particular preferably from 2 to 8 μm, very preferably from 2 to 7 μm.

The coating composition can be applied in method step (b) by any suitable method.

Usually, however, in method step (b) the coating composition is applied to the substrate using spraying, brushing, scraping, rolling, dipping or dip spinning. Particularly good results are obtainable if in method step (b) the coating composition is applied using dipping or dip spinning. Dipping or dip spinning is suitable in particular for coating mass bulk materials, such as small parts. It is particularly preferred in the context of the present invention if the coating composition is applied over the entire surface of the substrate or the cathodic corrosion protection coating.

The temperature at which the coating composition is dried in method step (c) can vary over a wide range depending on the substrate selected, the cathodic corrosion protection coating applied thereto and the coating composition applied.

However, it has proved useful if in method step (c) the coating composition is dried at temperatures in the range from 20 to 300° C., in particular 30 to 250° C., preferably 40 to 200° C., preferentially 50 to 180° C., in particular preferably 55 to 160° C., most preferably 60 to 150° C.

At the above temperatures, rapid drying or curing and/or crosslinking of the binding agent systems usually takes place, wherein decomposition of the organic binding agent is avoided.

Similarly, it has been found convenient if in method step (c) the coating composition is dried for a period of 1 to 30 minutes, in particular 2 to 25 minutes, preferably 3 to 20 minutes, preferentially 5 to 15 minutes.

As previously stated, it is possible within the scope of the present invention to set the coefficient of friction of the resulting coating, in particular of the topcoat, in a targeted manner. Particularly good results are thereby obtained if the coefficient of friction of the coated substrate is set in the range from 0.09 to 0.16, determined according to DIN EN ISO 16047:2013-01, by applying the coating composition. The friction coefficient is set in particular by the amount of organic binding agent and the type and amounts of lubricant.

For further details on this aspect of the invention, reference can be made to the previous explanations on the other aspects of the invention, which apply according to the method according to the invention.

Finally, a further subject-matter of the present invention—according to a fourth aspect of the present invention—is a metallic substrate comprising, in particular obtainable with a coating composition as described above or according to a method as described above.

Typically, the substrate still comprises a cathodic corrosion protection coating between the coating, i.e. the cured coating composition, in particular the topcoat, in particular in the form of a basecoat.

In the context of the invention, it is preferred if the coating contains the lubricant in amounts of 1 to 25 wt. %, in particular 1 to 20 wt. %, preferably 1.5 to 17 wt. %, preferentially 2 to 15 wt. %, particularly preferred 2.5 to 12 wt. %, based on the coating.

Typically, the coating, in particular the topcoat, contains the organic binding agent in amounts of 60 to 99 wt. %, in particular 65 to 99 wt. %, preferably 70 to 98 wt. %, preferentially 75 to 97 wt. %, particularly preferred 80 to 96 wt. %, based on the coating, in particular the topcoat.

If a mixture of organic and inorganic binding agents is used in the context of the present invention, it has been well proven if the coating, in particular the topcoat, contains the organic binding agent in amounts of 25 to 70 wt. %, in particular 30 to 65 wt. %, preferably 35 to 60 wt. %, preferentially 40 to 55 wt. %, particularly preferred 43 to 53 wt. %, based on the coating, in particular the topcoat.

Similarly, it is preferred in the context of the present invention according to this embodiment if the coating, in particular the topcoat, contains the inorganic binding agent in amounts of 25 to 70 wt. %, in particular 30 to 65 wt. %, preferably 35 to 65 wt. %, preferentially 40 to 55 wt. %, particularly preferred 43 to 53 wt. %, based on the coating, in particular the topcoat.

It is further well proven if the ratio by weight of organic binding agent to inorganic binding agent is in the range of 1.5:1 to 1:2, in particular 1.5:1 to 1:1.5, preferably 1.1:1 to 1:1.1, based on the weight of organic binding agent and the weight of inorganic binding agent in the coating, in particular the topcoat.

It is also preferred if the coating, in particular the topcoat, contains the platelet-shaped particles in amounts of 0.5 to 20, in particular 1 to 15 wt. %, preferably 1.5 to 12 wt. %, preferentially 1.5 to 10 wt %, based on the coating, in particular the topcoat.

Particularly good results are obtained in this context if the coating contains a total amount of lubricant and platelet-shaped particles in the range of 1.5 to 45 wt. %, in particular 2 to 35 wt. %, preferably 3.5 to 25 wt. %, preferentially 4 to 20 wt. %, based on the coating composition.

The coating, in particular the topcoat, thereby preferably comprises a layer thickness in the range from 1 to 10 μm, in particular 1 to 8 μm, preferably 1 to 7 μm, preferentially 2 to 7 μm, particularly preferred 2 to 6 μm.

Furthermore, it is preferred if the coefficient of friction of the coated substrate varies in the range from 0.09 to 0.16, determined according to DIN EN ISO 16047:2013-01.

For further details on the substrate according to the invention, reference can be made to the above explanations on the other aspects of the invention, which apply accordingly with respect to the substrate according to the invention.

The subject-matter of the present invention is illustrated below with reference to the embodiments in an exemplary and non-limiting manner.

### WORKING EXAMPLES

To further illustrate the present invention and its advantages, several series of tests were carried out with topcoat compositions according to the invention, which are applied to screws. The sliding and frictional properties of the screws are then determined.

### Examples 1 to 3

First, the properties of a topcoat composition exclusively comprising an organic binding agent based on an acrylic ester/methacrylic ester/styrene copolymer are investigated. Micronized polyethylene waxes and thickeners (RheoByk 7420 ES and Optigel) are added to the compositions. The coating compositions are given in Table 1 below.

TABLE 1
Topcoat compositions with organic binding agent

| Composition | 1 | 2 | 3 |
|---|---|---|---|
| Acrylic acid ester/methacrylic acid | 13 | 13 | 13 |
| ester/styrene copolymer | | | |
| [wt. %] | | | |
| Micronized PE wax | 3 | 3 | 3 |
| [wt. %] | | | |
| RheoByk 7420 ES [wt. %] | 0.3 | 0.9 | — |
| Optigel [wt.-%] | — | — | 10.0 |
| Water [wt.-%] | 83.7 | 83.1 | 77 |

Using dip spinners, the coating compositions are applied to the full surface of screws with a layer thickness of 7 μm and then dried at 120° C. for 20 minutes.

The screws are then subjected to a friction coefficient determination according to DIN EN ISO 16047:2013-01. It is found that both the total coefficient of friction and the coefficient of friction in the head and thread each lie within the specified VDA window of 0.09 to 0.16.

For further investigation, the multiple tightening (5 tightenings) is examined on a steel surface, a surface provided with an organic cathodic dip coating (KTL) and an aluminum surface. It is shown that the friction coefficient window for multiple suits is only observed on steel. All three coating compositions show excellent heat release behavior. The values are given in Table 2 below.

TABLE 2
Investigation of friction and sliding properties

| Composition | 1 | 1 | 3 |
|---|---|---|---|
| CoF total | 0.114 | 0.106 | 0.095 |
| | 0.104-0.123 | 0.098-0.113 | 0.088-0.104 |
| CoF head | 0.110 | 0.094 | 0.084 |
| | 0.101-0.132 | 0.088-0.099 | 0.076-0.091 |
| CoF thread | 0.119 | 0.122 | 0.109 |
| | 0.108-0.130 | 0.111-0.142 | 0.100-0.121 |
| Multiple tightening steel | 10.117 | 10.110 | 10.105 |
| | 30.121 | 30.120 | 30.110 |
| | μₜₒₜ¹ 0.117-0.129 | μₜₒₜ 0.110-0.124 | μₜₒₜ 0.105-0.111 |
| | μₜₕ² 0.126-0.126 | μₜₕ 0.112-0.121 | μₜₕ 0.114-0.110 |
| | μ_{b}³ 0.110-0.131 | μ_{b} 0.108-0.126 | μ_{b} 0.099-0.112 |
| Multiple tightening KTL | 10.083 | 10.080 | 10.077 |
| | 50.082 | 50.079 | 50.078 |
| | μₜₒₜ 0.083-0.082 | μₜₒₜ 0.080-0.079 | μₜₒₜ 0.077-0.078 |
| | μₜₕ 0.079-0.076 | μₜₕ 0.079-0.077 | μₜₕ 0.077-0.080 |
| | μ_{b} 0.085-0.086 | μ_{b} 0.080-0.080 | μ_{b} 0.077-0.077 |
| Multiple tightening Alu | 10.080 | 10.080 | 10.077 |
| | 20.081 | 20.080 | 20.079 |
| | μₜₒₜ 0.080-0.081 | μₜₒₜ 0.080-0.080 | μₜₒₜ 0.077-0.079 |
| | μₜₕ 0.078-0.072 | μₜₕ 0.080-0.074 | μₜₕ 0.076-0.074 |
| | μ_{b} 0.081-0.087 | μ_{b} 0.080-0.084 | μ_{b} 0.078-0.083 |
| Coating weight | 0.023 | 0.027 | 0.038 |
| Heat release | 0.064 | 0.062 | 0.063 |

¹μₜₒₜ: Total friction coefficient
²μₜₕ: Friction coefficient on thread
³μ_{b}: Friction coefficient on head

### Examples 4 and 5

In addition to the above tests 1 to 3, tests were carried out with an acrylic acid copolymer as binding agent. The compositions are given in Table 3 below and the tests on the friction and slip properties in Table 4 below. It can also be seen from Table 4 that the hot soldering properties of compositions 4 and 5 are excellent. The coefficients of friction are also always within the VDA window. This is also the case with multiple tightening, both on steel, a KTL and on aluminum.

TABLE 3
Topcoat compositions with organic binding agent

| Composition | 4 | 5 |
|---|---|---|
| Acrylic acid -Copolymer | 18 | 18 |
| [wt. %] | | |
| Micronized PE wax | 2 | 2 |
| [wt. %] | | |
| RheoByk 7420 ES [wt.-%] | 0.3 | — |
| Optigel [wt.-%] | — | 5 |
| Water [wt.-%] | 78.7 | 75 |

TABLE 4
Investigation of friction and sliding properties

| Composition | 4 | 5 |
|---|---|---|
| CoF total | 0.123 | 0.116 |
| | 0.104-0.132 | 0.102-0.122 |
| CoF head | 0.129 | 0.122 |
| | 0.106-0.144 | 0.113-0.127 |
| CoF thread | 0.116 | 0.109 |
| | 0.102-0.123 | 0.089-0.119 |
| Multiple tightening steel | 10.111 | 10.112 |
| | 30.110 | 30.113 |
| | μₜₒₜ¹ 0.111-0.114 | μₜₒₜ 0.112-0.114 |
| | μₜₕ² 0.112-0.098 | μₜₕ 0.114-0.100 |
| | μ_{b}³ 0.110-0.125 | μ_{b} 0.112-0.124 |
| Multiple tightening KTL | 10.107 | 10.097 |
| | 50.124 | 50.113 |
| | μₜₒₜ 0.107-0.124 | μₜₒₜ 0.097-0.113 |
| | μₜₕ 0.099-0.097 | μₜₕ 0.096-0.091 |
| | μ_{b} 0.114-0.142 | μ_{b} 0.098-0.129 |
| Multiple tightening Alu | 10.121 | 10.116 |
| | 20.128 | 20.126 |
| | μₜₒₜ 0.121-0.128 | μₜₒₜ 0.116-0.126 |
| | μₜₕ 0.095-0.090 | μₜₕ 0.100-0.098 |
| | μ_{b} 0.140-0.156 | μ_{b} 0.127-0.147 |
| Coating weight | 0.009 | 0.015 |
| Heat release | 0.063 | 0.063 |

¹μₜₒₜ: Total friction coefficient
²μₜₕ: Friction coefficient on thread
³μ_{b}: Friction coefficient on head

### Examples 6 to 9

In examples 6 to 9, a mixture of an organic ethylene-acrylic acid copolymer and an inorganic binding agent in the form of a colloidal silicic sol is used. Thickeners and micronized polyethylene waxes are added to each of the compositions 6 to 9 in amounts of 1 wt. %.

The compositions are given in Table 5 below. The compositions are reapplied to the screws and tested for their frictional properties. The results of the tests are given in Table 6 below. It can be seen that the coefficients of friction are always within the desired VDA window.

TABLE 5
Topcoat compositions with organic and inorganic binding agent

| Composition | 6 | 7 | 8 | 9 |
|---|---|---|---|---|
| Ethylene-acrylic acid copolymer | 20 | 20 | 20 | 20 |
| [wt. %] | | | | |
| Colloidal silicic sol [wt. %] | 13 | 13 | 13 | 13 |
| Micronized PE wax | 1 | 1 | 1 | 1 |
| [wt. %] | | | | |
| RheoByk 7420 ES [wt. %] | 0.9 | 0.8 | — | — |
| Optigel [wt. %] | — | — | 5 | — |
| Water [wt. %] | 78.7 | 78.1 | 69 | |

TABLE 6
Investigation of friction and sliding properties

| Composition | 6 | 7 | 8 | 9 |
|---|---|---|---|---|
| CoF total | 0.116 | 0.110 | 0.109 | 0.117 |
| | 0.113-0.120 | 0.099-0.114 | 0.104-0.113 | 0.111-0.121 |
| CoF head | 0.119 | 0.110 | 0.110 | 0.115 |
| | 0.109-0.125 | 0.093-0.117 | 0.103-0.114 | 0.107-0.120 |
| CoF thread | 0.112 | 0.112 | 0.107 | 0.120 |
| | 0.103-0.123 | 0.105-0.119 | 0.102-0.112 | 0.112-0.129 |
| Coating weight | 0.040 | 0.033 | 0.035 | 0.019 |
| Run-down time | 30″ | 27″ | 32″ | 25″ |
| Heat release | — | — | — | 0.070 |

### Examples 10 to 17

Furthermore, two series of tests are carried out in which, on the one hand, an organic binding agent based on an acrylic acid copolymer is used (examples 10 to 13). In addition, an inorganic binding agent in the form of a colloidal silicic sol is used in a second series of tests (Examples 14 to 17).

The compositions of test series 1 (examples 10 to 13) are given in Table 7 and the examples of test series 2 (examples 14 to 17) in Table 9.

The compositions are each applied to bolts and examined for their sliding and frictional properties. The results of these tests are shown in Tables 8 and 10.

It is shown that both the topcoats 10 to 13 with a purely organic binding agent and the topcoats 14 to 17 with a mixture of an organic and an inorganic binding agent comprise excellent properties.

All topcoats meet the VDA specifications in terms of coefficient of friction, total coefficient of friction, coefficient of friction at the head and coefficient of friction at the thread. The heat release behavior is also always acceptable.

TABLE 7
Topcoat compositions with organic binding agent

| Composition | 10 | 11 | 12 | 13 |
|---|---|---|---|---|
| Ethylene-acrylic acid copolymer | 15 | 15 | 15 | 15 |
| [wt. %] | | | | |
| Micronized PE wax | 1 | 1 | 1 | 1 |
| [wt. %] | | | | |
| RheoByk 7420 ES [wt. %] | 0.9 | — | — | — |
| Optigel [wt. %] | — | 5 | 10 | — |
| Water [wt. %] | 83.1 | 79 | 74 | 84 |

TABLE 8
Investigation of friction and sliding properties

| Composition | 10 | 11 | 12 | 13 |
|---|---|---|---|---|
| CoF total | 0.122 | 0.123 | 0.112 | 0.116 |
| | 0.117-0.129 | 0.118-0.127 | 0.102-0.121 | 0.113-0.119 |
| CoF head | 0.120 | 0.124 | 0.108 | 0.128 |
| | 0.111-0.125 | 0.120-0.128 | 0.104-0.114 | 0.125-0.131 |
| CoF thread | 0.125 | 0.122 | 0.118 | 0.101 |
| | 0.112-0.137 | 0.109-0.136 | 0.100-0.130 | 0.094-0.108 |
| Coating weight | 0.013 | 0.011 | 0.014 | — |
| Run-down time | 30″ | 29″ | 34″ | — |
| Heat release | 0.053 | 0.064 | 0.062 | 0.060 |

TABLE 9
Topcoat compositions with organic and inorganic binding agent

| Composition | 14 | 15 | 16 | 17 |
|---|---|---|---|---|
| Ethylene-acrylic acid copolymer | 15 | 15 | 15 | 15 |
| [wt. %] | | | | |
| Colloidal silicic sol [wt. %] | 13 | 13 | 13 | 13 |
| Micronized PE wax | 1 | 1 | 1 | 1 |
| [wt. %] | | | | |
| RheoByk 7420 ES [wt. %] | 0.9 | 0.8 | — | — |
| Optigel [wt. %] | — | — | 5 | — |
| Water [wt. %] | 70.1 | 70.2 | 66 | 71 |

TABLE 10
Investigation of friction and sliding properties

| Composition | 14 | 15 | 16 | 17 |
|---|---|---|---|---|
| CoF total | 0.118 | 0.110 | 0.114 | 0.116 |
| | 0.111-0.130 | 0.104-0.122 | 0.101-0.120 | 0.106-0.127 |
| CoF head | 0.114 | 0.105 | 0.108 | 0.116 |
| | 0.102-0.126 | 0.099-0.114 | 0.097-0.121 | 0.102-0.128 |
| CoF thread | 0.123 | 0.118 | 0.122 | 0.115 |
| | 0.115-0.134 | 0.109-0.132 | 0.107-0.134 | 0.102-0.125 |
| Coating weight | 0.028 | 0.031 | 0.029 | — |
| Run-down time | 48″ | 31″ | 42″ | — |
| Heat release | 0.067 | 0.063 | 0.063 | 0.061 |

### Examples 18 to 28

Furthermore, tests are carried out with binding agent systems containing an organic binding agent in the form of an acrylic acid copolymer and an inorganic binding agent in the form of a colloidal silicic sol and to which various lubricants are added.

Using dip spinners, the coating compositions are applied to the full surface of screws with a layer thickness of 7 μm and then dried at 150° C. for 30 minutes.

The screws are then subjected to a coefficient of friction determination in accordance with DIN EN ISO 16047:2013-01.

TABLE 11
Topcoat compositions with organic and inorganic
binding agents (50% organic and 50% inorganic)

| Composition | 18 | 19 | 20 | 21 |
|---|---|---|---|---|
| Ethylene-acrylic acid copolymer | 15 | 15 | 15 | 15 |
| [wt. %] | | | | |
| Colloidal silicic sol [wt. %] | 15 | 15 | 15 | 15 |
| Lubricant [wt. %] | graphite | graphite | graphite | oS₂ |
| | 3 | 5 | 7 | 5 |
| Water [wt. %] | 77 | 75 | 73 | 75 |

TABLE 12
Topcoat compositions with organic and inorganic
binding agent (30% organic and 70% inorganic)

| Composition | 22 | 23 | 24 | 25 |
|---|---|---|---|---|
| Ethylene-acrylic acid copolymer | 9 | 9 | 9 | 9 |
| [wt. %] | | | | |
| Colloidal silicic sol [wt. %] | 21 | 21 | 21 | 21 |
| Lubricant [wt. %] | boron nitride | graphite | MoS₂ | MoS₂ |
| | 5 | 5 | 3 | 5 |
| Water [wt. %] | 75 | 75 | 77 | 75 |

TABLE 13
Investigation of friction and sliding properties

| Composition | 18 | 19 | 20 | 21 |
|---|---|---|---|---|
| CoF total | 0.107 | 0.137 | 0.120 | 0.116 |
| | 0.094-0.116 | 0.133-0.145 | 0.116-0.123 | 0.096-0.133 |
| CoF head | 0.117 | 0.153 | 0.137 | 0.115 |
| | 0.098-0.142 | 0.148-0.161 | 0.129-0.143 | 0.094-0.141 |
| CoF thread | 0.094 | 0.116 | 0.097 | 0.118 |
| | 0.083-0.108 | 0.108-0.130 | 0.092-0.104 | 0.099-0.0136 |
| Coating weight | 0.034 | 0.034 | 0.043 | 0.024 |
| Composition | 22 | 23 | 24 | 25 |
| CoF total | 0.115 | 0.115 | 0.117 | 0.104 |
| | 0.101-0.127 | 0.111-0.119 | 0.084-0.146 | 0.081-0.120 |
| CoF head | 0.121 | 0.119 | 0.107 | 0.100 |
| | 0.103-0.133 | 0.113-0.129 | 0.090-0.135 | 0.081-0.117 |
| CoF thread | 0.107 | 0.109 | 0.131 | 0.109 |
| | 0.097-0.120 | 0.096-0.126 | 0.059-0.162 | 0.081-0.134 |
| Coating weight | 0.031 | 0.031 | 0.026 | 0.025 |

1. Aqueous coating composition for producing a coating with an adjustable coefficient of friction, the coating composition comprising:
an organic binding agent, wherein the binding agent comprises a copolymer of at least one unsaturated hydrocarbon and at least one unsaturated carboxylic acid; and
a lubricant.

2. The coating composition according to claim 1, wherein the at least one unsaturated hydrocarbon is selected from the group of aliphatic hydrocarbons with vinyl groups, aromatic hydrocarbons with vinyl groups, aliphatic hydrocarbons with alkynyl groups, aromatic hydrocarbons with alkynyl groups and mixtures thereof.

3. Coating The coating composition according to claim 1, wherein the at least one unsaturated hydrocarbon is selected from aliphatic and/or aromatic C2- to C20-compounds with alkynyl groups, aliphatic and/or aromatic C2- to C20-compounds with vinyl groups and mixtures thereof.

4. The coating composition according claim 1, wherein the at least one unsaturated carboxylic acid is selected from C2- to C20-alkenoic acids.

5. The coating composition according to claim 1, wherein the at least one unsaturated carboxylic acid is selected from the group of acrylic acid, esters of acrylic acid with C1- to C10-alcohols, methacrylic acid, esters of methacrylic acid with C1- to C10-alcohols, fumaric acid, and maleic acid.

6. The coating composition according to claim 1, comprising the organic binding agent in amounts of 2 to 70 wt. % based on the coating composition.

7. The coating composition according to claim 1, wherein the lubricant is selected from the group of organic lubricants, inorganic lubricants and mixtures thereof.

8. The coating composition according to claim 1, wherein the lubricant is selected from the group of waxes, graphene, graphite, boron nitride, molybdenum disulfide, plastic particles.

9. The coating composition according to claim 1, comprising the lubricant in amounts of 0.1 to 10 wt. % based on the coating composition.

10. The coating composition according to claim 1, wherein the coating composition is free of fluorine-containing compounds.

11. The coating composition according to claim 1, wherein the coating composition comprises platelet-shaped particles.

12. The coating composition according to claim 1, further comprising an inorganic binding agent.

13. The coating composition according to claim 12, wherein the inorganic binding agent is selected from silanes, silane hydrolysates, silicates, polysiliconates and mixtures thereof.

14. A coating composition comprising:
an organic binding agent, wherein the binding agent comprises a copolymer of at least one olefin and at least one unsaturated carboxylic acid;
an inorganic binding agent; and
a lubricant.

15. A method comprising using the coating composition according to claim 1 as a topcoat for producing a coating with an adjustable coefficient of friction on a metallic substrate.

16. A method for producing a coating with a selectively adjustable coefficient of friction, the method comprising:
providing a substrate having a cathodic corrosion protection coating at least in some areas thereof;
applying the coating composition according to one claim 1 to the substrate in the at least in some areas thereof; and
drying the coating composition applied to the substrate.

17. The method according to claim 16, wherein the coefficient of friction of the coated substrate is set in the range from 0.09 to 0.16, determined according to DIN EN ISO 16047:2013-01.

18. A metallic substrate comprising a coating, obtainable via the coating composition according to claim 1.

19. The metallic substrate according to claim 18, wherein the coating comprises the lubricant in amounts of 1 to 25 wt. % based on the coating.

20. The metallic substrate according to claim 18, wherein the coating comprises the organic binding agent in amounts of 60 to 99 wt. % based on the coating.
